(19) United States
(12) Patent Application Publication
(10) Pub. No.: US 2012/0202023 A1
(43) Pub. Date: Aug. 9, 2012

(54) ENAMELED REFLECTIVE GLASS PANEL

(75) Inventor: Laurent Dusoulier, Jumet (BE)

(73) Assignee: AGC Glass Europe, Bruxelles(Watermael-Boitsfort) (BE)

(21) Appl. No.: 13/502,220

(22) PCT Filed: Oct. 15, 2010
(86) PCT No.: PCT/EP10/65516

§ 371 Date: Apr. 16, 2012

(30) Foreign Application Priority Data
Oct. 16, 2009 (EP) 09173300.6

(51) Int. Cl. B32B 17/06; B32B 3/10; B32B 18/00

(52) U.S. Cl. 428/210; 428/426; 428/428; 428/432

(57) ABSTRACT

The invention relates to a glass panel comprising a system of vacuum-deposited layers having solar radiation filtering properties, said system being at least partially coated with an enamel layer.

The present invention relates to glazing units comprising a system of layers deposited under vacuum and an enamel layer in at least partial contact with this system of layers.

The envisaged combination is typical of those that are found in certain glazing units used, for example, in the construction industry for forming spandrel panels. In the remainder of the description, when speaking of the products targeted by the invention, reference will be made to spandrel panels, it being understood that this is only by way of simplification, since the invention covers all of the products in which the combination of a system of dielectric layers is present with at least one enamel in contact with this system and at least partially covering it.

More specifically, one important application of the glazing units according to the invention relates to glass-clad buildings. For these buildings, considering the surface areas in question, the glazing units used normally comprise systems of layers that have properties of controlling the radiated energy in order to limit the need for air conditioning (solar control properties) and properties of reducing the energy emitted by the building (insulation properties). The buildings are frequently practically completely clad. Therefore, the glazing units cover both the parts that must offer a significant light transmission, and those for which the transmission is practically zero. The latter correspond in particular to the structural elements. For this purpose, it is customary to use opaque enamel layers to hide these elements.

The glazing units used, seen from the outside of the buildings, preferably offer improved esthetics. For this reason, it is conventional to retain the system of layers even in the parts coated with enamel, which may result in the superimposition of a system of layers and of the enamel.

Solar-protection or low-emissivity coatings may be applied in various ways depending on the nature of the layers. For pyrolytic-type depositions, the layers formed are, as a general rule, highly resistant. However, even on these layers, the application of the enamel layer may lead to the appearance of defects. Vacuum depositions offer a variety of properties that cannot always be obtained with the layers deposited by pyrolysis. Nevertheless, the systems of layers formed by vacuum deposition, of the cathode sputtering type, are as a general rule much more brittle and create visible defects after deposition of the enamel.

The enamels used for these applications typically consist of a composition comprising a glass frit intended to form the glassy matrix, and of coloring pigments. The composition also comprises a medium that enables the application of the frit/pigments mixture, which ensures a good suspension of the solid particles and is removed during the firing of the enamel. This medium comprises solvents, resin oils, etc.

In practice, in particular during the firing of the enamel, an operation which is carried out at temperatures of the order of 550-700° C., modifications may arise in the layers in contact with this enamel. Reactions of undefined nature lead to a deterioration in the appearance of the glazing unit. Marks are formed which modify their appearance.

The inventors have sought a means for preventing the appearance of defects in products of this type.

The invention proposes glazing units comprising a system of dielectric layers deposited under vacuum, which system has solar radiation screening properties, the system of layers being at least partly coated with an enamel. The inventors have established that it was possible to choose the components of the system of layers so that this system is not adversely affected by the contact with the enamel composition.

The glazing units according to the invention comprise a system of layers deposited under vacuum, having solar radiation screening properties in the absence of the enameled coating, the system of layers comprising at least one surface resistant layer, this layer being based on titanium oxide, on niobium oxide, on tantalum oxide, or on mixed oxides of the aforegoing, or with other metal oxides.

Among the additional oxides, those of the metals from the group consisting of Al, Zr, Hf, V, Mn, Fe, Co, Ni, Cu, Si, Cr, Ta and Nb are advantageous.

The surface layer may also contain additional elements in a very low proportion, in general less than 8% by weight and usually less than 5%. These are in particular dopants, the role of which is mainly to improve the manufacture and/or use of the cathodes in the production of the layers in the vacuum deposition techniques. These elements are conventionally intended, in particular, for improving the conductivity of the materials constituting cathodes, such as: Ti, Al. They may also be compounds that stabilize certain constituents, such as Ca, Mg, or else elements that appear to be indissociable from others during the preparation. This is the case for lanthanides such as yttrium oxide or hafnium oxide.

When titanium oxide is chosen as the basis for the surface resistant layer, it is inevitably combined with at least one other metal oxide which reinforces its resistance. Specifically, it appears that titanium oxide, which offers good optical properties, is insufficiently resistant to mechanical or chemical stresses. Conversely, tantalum or niobium oxides may be used alone (apart from possible dopant elements present).

When a layer based on titanium oxide is chosen, it contains at least 40% and at most 95% by weight of titanium oxide.

It goes without saying that the glazing unit comprising the system of layers, when it is coated with enamel, is practically opaque. The light transmission of the enameled glazing unit is in all cases less than 5%, and usually less than 2%. The purpose of the presence of the system of layers under the enamel is to maintain the properties, and especially the reflection properties, which are those of the glazing unit that does not comprise an enameled coating. Specifically, the important thing is to maintain a similar outer appearance for the transparent parts of the glazing units and those which are not transparent. This requirement is all the more important since the reflection is itself higher. Advantageously, the glazing units according to the invention comprise a system of layers such that, applied to a clear float glass having a thickness of 4 mm, the reflection on the side of the glass sheet facing the system of layers would be at least 15% of the incident sunlight, and the transmission at least 60%.

Preferably, the glazing units according to the invention comprise a reflective system of layers that, applied to a 4 mm sheet of clear float glass, would result in a reflection of between 20% and 40% of the incident sunlight.

Apart from the highly resistant surface reflective layer constituted as indicated above, the system may comprise other layers between this reflective layer and the glass sheet.

Additional layers are used in particular for preventing the diffusion of alkali metal ions from the glass substrate. These additional layers may also improve the mechanical strength or the optical properties of the system of layers and especially the reflective nature.

Preferred “barrier” sublayers used for improving the protection against the diffusion of alkali metal ions from the glass sheet are for example constituted of at least one of the compounds of silicon: the oxide (SiO₂) , the nitride (Si₃N₄) or the oxynitride (SiON); or oxides of SnO₂ and oxides composed of tin and zinc (up to 50% by weight of zinc oxide), or else TiO₂ that is optionally substoichiometric or optionally in the form of oxynitride containing a low content of nitrogen (N/O less than 10%).

By way of indication, the barrier sublayers formed based on SiO₂ have an index of the order of 1.5 when that of TiO₂ is of the order of 2.5.

When the additional layers have a refractive index that is not very high, their thickness is preferably chosen to be relatively thinner than that of the reflective layer or layers so as not to impair the properties in question. The optical pathlength corresponding to this low-index barrier layer advantageously does not represent more than a quarter of the optical pathlength of all of the layers of the system.

Advantageously, when one or more sublayers are used to contribute to the reflective properties of the system, they are chosen with a refractive index that is as high as possible and preferably greater than 2.2. Various reflective layers can be used, especially layers of titanium oxide, niobium oxide, tantalum oxide, zirconium oxide, optionally in suboxide form or in oxynitride form.

Unlike the surface layer, when a sublayer that improves the reflection is based on titanium oxide, it is not necessary to combine this oxide with elements that improve the resistance thereof. Being under the in principle resistant reflective layer, this sublayer does not, by itself, have to offer the same qualities. The usefulness of such a TiO₂ layer without addition of another oxide lies in the high index that it has compared to that of the mixed oxides of titanium and of at least one other metal. These mixed oxides, although forming a significant reflective layer, at equal thickness, reflect less than titanium oxide alone. The combination of a titanium oxide primer layer in contact with the glass and of a layer of mixed oxide of titanium and of another metal combines both the overall advantage of a high refractive index and of good surface resistance.

The use of a high-index titanium oxide layer may not, however, exhibit the best set of properties, in particular mechanical properties. The relatively thick layers of TiO₂ are not necessarily the most suitable. This may also lead to the thickness of the subjacent layer of TiO₂ (or TiOₓ or TiOₓNy), of other layers having a relatively high index that complete the system, including in particular another layer of mixed titanium oxide, the other metal of which has a nature that is the same as or different to that of the metal of the surface layer, being limited.

A typical assembly comprises, for example, in addition to the very resistant surface layer, one or more layers having a high refractive index, and a barrier layer. An assembly of reflective layers of this type is, for example, a succession of layers comprising a surface layer based on a mixed titanium and zirconium oxide composition, in contact with this a layer of titanium oxide advantageously deposited from a ceramic cathode of optionally doped titanium oxide, and resulting in a slightly substoichiometric oxide layer, under this layer another layer of mixed oxide of titanium oxide and of another oxide of the type of those which may be used in the surface layer.

The reflective layers deposited under vacuum under good conditions do not normally give rise to light-scattering phenomena. Conversely, in the absence of a surface protective layer according to the invention, the application of an enamel layer, and the firing thereof as indicated previously, adversely affect the optical properties by forming marks or at least the appearance of haze which adversely affect the appearance of these glazing units. Significant haze gives the appearance of a white halo. Furthermore, the presence of haze in these glazing units is not homogenous, which adds to the appearance defect.

Haze is defined by the expression:

H=R_{d}/R₁×100

in which R_{d} is the wide-angle dispersed reflection (scattered light), and R₁ the total reflection.

The glazing units according to the invention, the reflective layers of which are resistant, do not in practice develop this type of defect. The application and the firing of the enamel which covers the reflective layers does not lead to the formation of significant haze. Preferably, the glazing units according to the invention do not have a haze of greater than 3.5%, and preferably not greater than 2.5%. Under the best conditions, the haze is advantageously kept below 2%.

Although the enamel-coated glazing unit does not have significant marks or haze, certain optical qualities are nevertheless modified by the presence of the enamel. In particular, the reflection of the assembly may differ from that of the glazing unit that comprises only the reflective system of layers. This variation is however acceptable as long as the color variation in reflection remains limited.

For the glazing units according to the invention, the layers of the reflective system and also the color of the enamel used are such that the color variation in reflection ΔE of the enamel-coated glazing unit, compared to a glazing unit that does not comprise enamel, remains less than 3 and preferably less than 2.

E corresponds to the expression:

E=(a*²+b*²)^{1.2}

in which a* and b* are the colorimetric coordinates in the Hunter LAB system.

The condition indicated previously regarding the variation ΔE is satisfied even better when the enamel used is darker.

When the preceding condition is met, the variations in the reflection may be relatively large without, however, leading to a prejudicial difference in appearance. By way of indication, this difference in reflection with and without the enamel layer may attain 25% of the value in the absence of enamel, but is preferably less than 20%.

The glazing units according to the invention are produced with sheets of clear glass but also, and preferably, with sheets of colored glass. In building glass applications, the most common colors are gray, blue and green. The colors of the enamel are generally as neutral as possible. The enamels are essentially black but may exhibit slight differences.

Reported in the remainder of the description are examples of reflective systems of layers and their properties when these systems are coated with an enamel layer.

Systems of layers are especially constituted in the following manner, starting from the glass; the thicknesses given between parentheses are expressed in nanometers:
1. G/SnO₂ (15)/TZO (50);
2. G/Si₃N₄ (17)/TZO (38);
3. G/SiO₂ (10)/TZO (50);
4. G/SnO₂ (10)/TaO (20);
5. G/SnO₂ (10)/TaNbO (20);
6. G/SnO₂ (10)/TiOₓ (10)/TZO (30);
7. G/SiO₂ (40)/TiOₓ (10)/TZO (30).

In these systems, TZO is a layer constituted of a mixed oxide of titanium and zirconium containing 45% by weight of zirconium. It also comprises yttrium oxide (around 6%), which stabilizes the zirconium. Optionally, the layer also comprises oxides of aluminum, titanium or other elements which, incorporated into the cathodes, improve their conductivity and hence the stability of the deposition operation. TiOₓ denotes the titanium oxide deposited from a ceramic cathode and optionally having a slight substoichiometry. TaNbO is a mixed oxide of tantalum and niobium.

In the aforegoing, it is a matter of coating the system of layers with an enamel composition. This coating may be uniform over the whole of the glass sheet; it may also target only a portion thereof. In the same way, the application of the enamel may correspond to a given pattern applied to the sheet specifically for decorative purposes.

Systems of layers of the type 6 indicated above are applied by magnetron deposition to samples of clear, gray, blue and green, glass. The sheets of glass of the samples have a thickness of 6 mm.

Deposited onto the system in question is a layer of black enamel composition comprising 15% by weight of pigments (oxides of iron, of chromium and of cobalt), and 60% of a borosilicate-based frit, the rest being constituted of the application medium. The enamel is applied by screen printing to the whole of the surface of the sample precoated with the system of layers. The enamel is fired at 670° C. for 45 seconds per millimeter of glass thickness.

The table below gives, as Hunter coordinates (illuminant D65, 10°), the colorimetric qualities in reflection of the various samples. None of these samples shows significant haze (remains less than 1%).

The first sample is not coated with enamel in order to establish a comparison with the other samples.

| No., enamel | Glass | L* | a* | b* |
|---|---|---|---|---|
| I, no | clear | 63.1 | −2.2 | −3.8 |
| II, yes | clear | 44.6 | −2.2 | −2.3 |
| III, yes | green | 39.2 | −6.0 | −0.8 |
| IV, yes | blue | 35.2 | −3.6 | −8.1 |
| V, yes | gray | 31.5 | −0.3 | −2.4 |

Examples I and II show that the application of the enamel to the reflective layers does not significantly modify the color in reflection. The values a* and b* are practically identical. The presence of the enamel varies the luminance, in other words the intensity of the light reflected.

This observation is taken advantage of in the use of glazing units in which the coloration is provided by that of the glass sheet. Examples III and IV display shades of the types obtained with glasses that simultaneously offer significant reflection and a well-pronounced coloration. The application to gray glass of example V illustrates what can be obtained with a glass of more “neutral” coloration.

Other tests were carried out with systems of varied layers all deposited onto clear glass having a thickness of 6 mm. The table below indicates the nature and thickness of the layers of these systems and the colorometric characteristics before and after application of the enamel (as in the preceding examples) and also the measurement of the haze after firing of the enamel.

By way of comparison, a sample (C) is prepared that comprises a layer of titanium oxide obtained by gaseous pyrolysis (CVD) that in principle is more resistant.

The thicknesses reported are in nanometers. The values correspond first to those of the sample with the layers, and the last values are those of the same sample coated with enamel after firing. The first layer is deposited onto the glass. The surface layer is the second layer for examples 1 to 16. For examples 17 to 23, the surface layer is the third layer.

| | | 2^{nd} layer | L* | a* | b* | L* | a* | b* | Haze |
|---|---|---|---|---|---|---|---|---|---|
| | 1^{st} layer | and 3^{rd} layer | without enamel | | | with enamel | | | |
| C. | TiO₂ (45) | | 60 | −3.2 | −6.0 | 52.2 | −2.8 | −5.4 | 9.8 |
| 1 | TZO (30) | | 53.4 | −1.5 | −9.4 | 40.4 | −2.1 | −6.6 | 3.1 |
| 2 | ZSO50 (30) | TZO (30) | 58.0 | −1.9 | −0.4 | 41.6 | −2.3 | 2.1 | 1.2 |
| 3 | SnO₂ (10) | TaO (50) | 57.9 | −2.1 | −0.2 | 40.5 | −1.6 | 4.0 | 2.7 |
| 4 | SnO₂ (25) | TaO (25) | 55.8 | −2.2 | −4.8 | 46.9 | −2.2 | 0.7 | 2.2 |
| 5 | SnO₂ (25) | TaNbO (25) | 57.6 | −2.3 | −5.1 | 45.2 | −2.2 | −1.8 | 1.8 |
| 6 | SnO₂ (30) | TaNbO (20) | 56.8 | −2.2 | −5.1 | 44.2 | −2.1 | −1.6 | 1.6 |
| 7 | SnO₂ (25) | NbO (25) | 58.2 | −2.2 | −6.2 | 45.7 | −2.3 | −2.9 | 1.9 |
| 8 | Si₃N₄ (10) | TZO (50) | 61.7 | −2.1 | −1.7 | 47.4 | −2.4 | 0.2 | 3.2 |
| 9 | Si₃N₄ (17) | TZO (38) | 60.0 | −1.9 | −4.7 | 46.1 | −2.2 | −2.0 | 2.2 |
| 10 | SiO₂ (10) | TZO (50) | 61.4 | −2.1 | −5.4 | 46.7 | −2.6 | −2.5 | 1.8 |
| 11 | SiO₂ (30) | TZO (50) | 61.3 | −2.1 | −5.8 | 46.5 | −2.6 | −3.0 | 1.5 |
| 12 | TiOₓ (20) | TZO (20) | 61.7 | −1.9 | −8.2 | 45.1 | −2.1 | −5.8 | 2.2 |
| 13 | TiOₓ (30) | TZO (20) | 64.6 | −2.5 | 2.5 | 46.6 | −2.4 | 2.4 | 2.2 |
| 14 | SnO₂ (30) | TNO (30) | 61.8 | −2.4 | −2.4 | 49.1 | −2.4 | −0.8 | 1.3 |
| 15 | TiOₓ (30) | TNO (25) | 65.3 | −2.3 | −2.9 | 52.3 | −3.1 | 1.8 | 2.1 |
| 16 | TiOₓ (20) | TNO (30) | 65.1 | −2.2 | −6.0 | 51.8 | −3.1 | −0.8 | 2.4 |
| 17 | SiO₂ (40) | TiOₓ (10)/ | 59.59 | −1.98 | −9.09 | 46.3 | −2.2 | −6.4 | 1.49 |
| | | TZO (30) | | | | | | | |
| 18 | TZO (10) | TiOₓ (20)/ | 62.24 | −2.33 | 11.74 | 46 | −0.6 | 11.5 | 1.17 |
| | | TZO (40) | | | | | | | |
| 19 | TZO (5) | TiOₓ (10)/ | 58.81 | −1.99 | −8.48 | 44.7 | −2 | −5.9 | 1.66 |
| | | TZO (20) | | | | | | | |
| 20 | TZO (20) | TiOₓ (5)/ | 63.36 | −2.26 | 3.3 | 46.2 | −1.3 | 9.44 | 1.33 |
| | | TZO (40) | | | | | | | |
| 21 | SnO₂ (40) | TiOₓ (10)/ | 59.5 | −1.25 | 7.05 | 42.4 | −0.2 | 9.71 | 1.64 |
| | | TZO (30) | | | | | | | |
| 22 | SnO₂ (10) | TiOₓ (30)/ | 64.11 | −2.52 | 9.03 | 46.9 | −1.1 | 7.8 | 1.66 |
| | | TZO (30) | | | | | | | |
| 23 | SnO₂ (5) | TiOₓ (10)/ | 61.55 | −2.14 | −6.47 | 46.8 | −2.4 | −2.4 | 1.88 |
| | | TZO (30) | | | | | | | |

TZO is the layer of mixed oxide of titanium and zirconium described previously constituted of a mixed oxide of 50% by weight of TiO₂ and 46% of ZrO₂, the rest coming from elements that customarily accompany zirconium, in particular yttrium oxide.

ZSO50 is a layer of mixed oxide of tin and zinc in a 50/50 proportion by weight.

TaO denotes tantalum oxide (this is not the chemical formula but a generic designation, same for NbO and TaNbO as regards respectively niobium oxide or the mixed oxide of niobium and tantalum (50/50 atomic proportion)).

Metal targets of Ta, Nb and Ta—Nb are used, and the deposition is carried out in O₂ in order to obtain TaO, NbO and TaNbO.

TiOx is the titanium oxide deposited from ceramic cathodes.

TNO is the mixed oxide of titanium and niobium in a 50/50 weight proportion.

In the examples, it is observed that the layer of titanium oxide alone, even obtained by pyrolysis, has a substantial haze after application of the enamel layer.

The layers deposited under the conditions of the invention are significantly less affected.

Still in the examples according to the invention, the colors are slightly modified but the general shade is barely affected. The luminosity changes slightly, which is not prejudicial for spandrel panels.

The appended figures present the advantages linked to the use of the glazing units according to the invention as spandrel panels. In these figures:

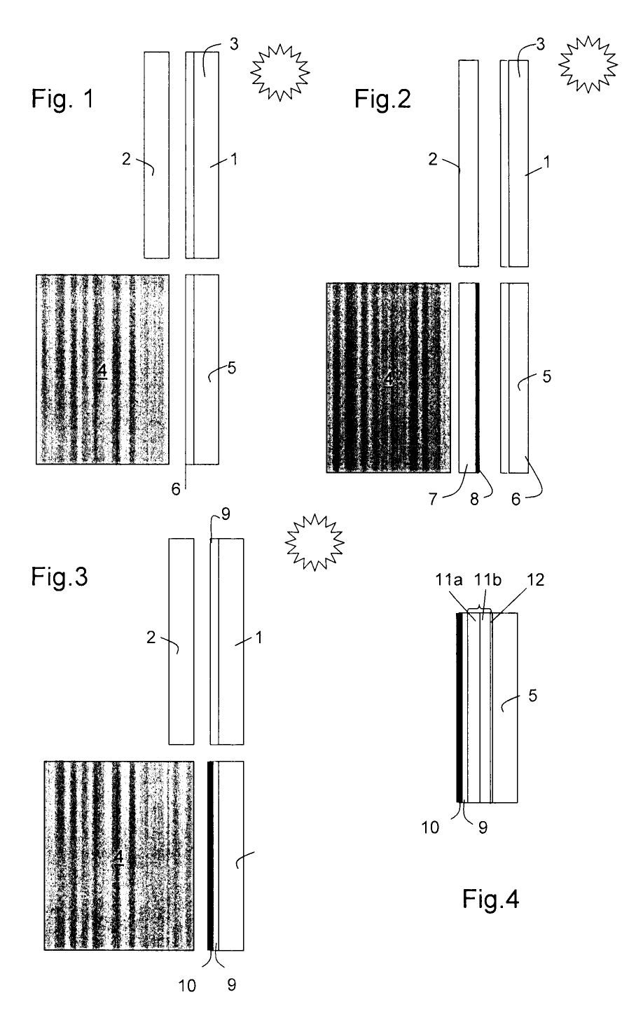

FIG. 1 represents the arrangement of a glazing unit as a facade for a building;

FIG. 2 represents a glazing unit similar to that of FIG. 1 comprising an enameled part;

FIG. 3 illustrates one way of using a glazing unit according to the invention; and

FIG. 4 schematically represents a glazing unit comprising a system of layers according to the invention with several reflective layers.

The facade of a glass-clad building comprises “vision” portions that allow significant transmission of the external light. This vision portion is represented by a double glazing unit (1, 2). Regarding insulating glazing, the two glass sheets define an enclosed space with the interlayer seals not represented. The sheet 1 is coated with a radiation-screening system of layers (3). This is, for example, a system that reflects a significant portion of the solar radiation.

The position of the system of layers (3) in the space of the insulating glazing protects it from possible adverse changes, either mechanical or on contact with the atmosphere. This arrangement is particularly desirable for the layers deposited under vacuum by cathode sputtering which are known to be relatively brittle compared to the “hard” layers formed by pyrolysis.

FIG. 1 also presents part of the structure of the building (4). In order to keep a uniform appearance of the exterior, it is customary to also provide a glazing unit (5) that has the same properties as those of the vision portion. In particular, in order to maintain an analogous reflection, this portion is also covered with a reflective layer (6).

In the configuration of FIG. 1, the structure of the building (4) is not concealed. The sheet 5 has the same light transmission as the sheet (3). The use of a masking enamel is therefore desired. Yet this enamel cannot be positioned on the outer face of the sheet 5, since the appearance in terms of color or reflection could not be kept analogous to that of the vision sheet. Covering the system of layers (6) deposited under vacuum with an enamel was previously unworkable due to defects and shade changes resulting from the interaction of the enamel with the system of layers due to the brittleness of the system.

FIG. 2 presents a prior solution intended to meet the need of combining the concealment of the structure (4) and the maintaining of the external appearance. To arrive at this result, the enamel (8) is applied to a sheet (7) different from that (5) bearing the reflective layer (6). In this configuration, the assembly of layers (5) and (7) does not strictly speaking form an “insulating” glazing unit insofar as it is not necessary for the space between these two sheets to be enclosed, and the sole function of the sheet (7) is firstly support for the enameled layer.

FIG. 3 illustrates a use of the glazing units according to the invention. This time, due to the improved behavior of the reflective system of layers (9), it is possible to coat it with the enamel (10). Therefore, a single sheet is capable of concealing the structure of the building and of maintaining the external appearance. A significant simplification is therefore made possible.

FIG. 4 schematically illustrates a coating according to the invention comprising a system containing multiple layers. In this representation, as before, the enamel layer (10) covers the resistant layer (9). Positioned under the latter are other reflective layers having a high refractive index (11a and 11b). These layers complement the effect of the surface layer (9) and improve the performances thereof. Where appropriate, a barrier layer (12) is also applied in order to prevent the migration of the alkali metal ions from the glass sheet (5).

1. A glazing unit comprising a system of layers deposited under vacuum having solar radiation screening properties, said system of layers being at least partly coated with an enamel layer.

2. The glazing unit of claim 1, wherein the system of layers comprises, in contact with the enamel layer, a surface layer comprises titanium oxide, niobium oxide, tantalum oxide or a mixture thereof, such that the titanium oxide is combined with at least one oxide of a metal selected from the group consisting of Ta, Nb, Al, Zr, Hf, V, Mn, Fe, Co, Ni, Cu, Si and Cr.

3. The glazing unit of claim 2, wherein the surface layer comprises titanium oxide, which represents at least 40% and at most 95% by weight of the surface layer.

4. The glazing unit of claim 1, wherein the system of layers is such that, applied to a sheet of clear glass having a thickness of 4 mm, it would result in a reflection, on the side of the sheet not applied with the system of layers, of at least 15% and a transmission of at least 60%.

5. The glazing unit of claim 4, wherein the system of layers is such that, applied to the sheet of clear glass having a thickness of 4 mm, it would result in a reflection, on the side of the sheet not applied with the system of layers, of between 20% and 40%.

6. The glazing unit of claim 4, wherein the system of layers comprises, in contact with the glass sheet, a barrier layer that protects against diffusion of alkali metals, said barrier layer comprising at least one compound selected from the group consisting of silicon oxide (SiO₂), silicon oxynitride (SiON), silicon nitride (Si₃N₄), and tin oxide, and optionally zinc oxide (up to 50% by weight of zinc), optionally substoichiometric titanium oxide TiO₂, a titanium oxynitride, or a combination thereof.

7. The glazing unit of claim 6, wherein the barrier layer has an optical pathlength not greater than a quarter of that of the system of layers.

8. The glazing unit of claim 2, comprising a refractive layer having a refractive index greater than 2.2 situated underneath the surface layer in contact with the enamel.

9. The glazing unit of claim 1, not having a haze of greater than 3.5%.

10. The glazing unit of claim 1, wherein a reflection on the uncoated side of the sheet results in a color difference before and after application of the enamel layer ΔE which is less than 3, E being defined by the expression E=(a*²+b*²)^{1/2} in the Hunter colorimetric system.

11. The glazing unit of claim 1, wherein the system of layers is selected from the group consisting of:
G/SnO₂/TZO;
G/Si₃N₄/TZO;
G/SiO₂/TZO;
G/SnO₂/TaO;
G/SnO₂/TaNbO;
G/SnO₂/TiOₓ/TZO; and
G/SiO₂/TiOₓ/TZO,
wherein:
G denotes glass;
TZO is a mixed oxide of titanium and zirconium comprising 45% by weight of zirconium and 6% of yttrium;
TaO is tantalum oxide;
TaNbO is a mixed oxide of tantalum and niobium (50/50 percentage by weight); and
TiOₓ is the titanium oxide deposited from ceramic cathodes.

12. A spandrel panel, comprising the glazing unit of claim 1.

13. A sheet coated with enameled decorative patterns, comprising the glazing unit of claim 1.

14. The glazing unit of claim 1, not having a haze of greater than 2.5%.

15. The glazing unit of claim 1, wherein a reflection on the uncoated side of the sheet results in a color difference before and after application of the enamel layer ΔE which is less than 2, E being defined by the expression E=(a*²+b*²)^{1/2} in the Hunter colorimetric system.
